(19) United States
(12) Patent Application Publication
(10) Pub. No.: US 2018/0018252 A1
(43) Pub. Date: Jan. 18, 2018

(54) SYSTEM AND METHOD FOR TRACKING, DETERMINING, AND REPORTING OVERALL EFFICIENCY AND EFFICACY OF CONTENT USAGE ACTIVITY

(71) Applicants: Tammy Ann Farrell, Oceanside, NY (US); Dulcina Bettencourt Belcher, Elk Grove, CA (US)

(72) Inventors: Tammy Ann Farrell, Oceanside, NY (US); Dulcina Bettencourt Belcher, Elk Grove, CA (US)

(21) Appl. No.: 15/628,176

(22) Filed: Jun. 20, 2017

Related U.S. Application Data
(60) Provisional application No. 62/361,279, filed on Jul. 12, 2016.

(51) Int. Cl. G06F 11/34; G06F 17/30; H04L 29/08

(52) U.S. Cl. CPC G06F 11/3495; H04L 67/22; G06F 17/30873; G06F 2201/875

(57) ABSTRACT

A tracking system for tracking and reporting content usage activity on computing devices is provided. The tracking system embodies a method determining overall efficiency and efficacy by measuring active usage time when the user is actually engaging or looking at the content. The method enables administrators to track and categorize any web site or application and run resulting ROI reports comparing quantified actual usage versus the recommended usage. Thereby the present invention may alert device users whose usage activity, as measured by the time usage on categorized sites and applications, deviates from recommended usage or predetermined thresholds.

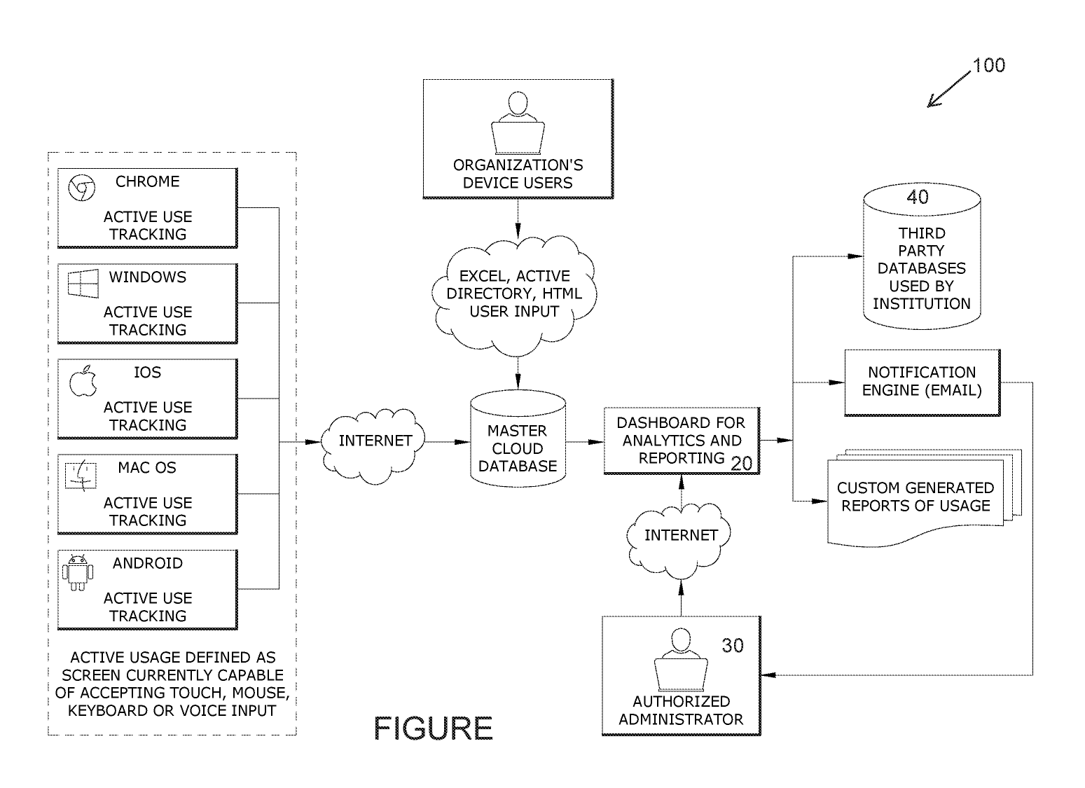

### CROSS-REFERENCE TO RELATED APPLICATION

This application claims the benefit of priority of U.S. provisional application No. 62/361,279, filed 12-Jul.-2016, the contents of which are herein incorporated by reference.

### BACKGROUND OF THE INVENTION

The present invention relates to tracking usage activity on computing devices and, more particularly, to a method for tracking and reporting usage activity on computing devices coupled to a computing environment for determining overall efficiency and efficacy thereof.

When an institution uses computer hardware, software and digital content, they often are unaware which resources are being used effectively, which resources are under-utilized, and which resources deliver no meaningful outcomes. This is because institutions lack the proper tools for tracking the efficiency and efficacy of such program usage. Institutions also lack tools to help identify users who have become dis-engaged, and whose work is starting to show decline.

Previously, systems offered minimal and disparate methods for collecting usage data, and virtually no method for analyzing that data, leaving institutions unable to determine if they were seeing a return on their investment when using specific web sites or applications, let alone if individual users were becoming dis-engaged in their efforts. Moreover, vendor-supplied usage data is disparate and may be intentionally inaccurate to benefit the vendor.

While there are some tracking mechanisms that exist, they are either restricted to data collected while logged into select systems, or only measuring hits to a pre-populated list of applications. By using a pre-populated list of web sites and applications, these solutions make false assumptions that users are always focused on work-related tasks. Furthermore, today's systems fail to recognize that users can have multiple screens, including web pages and applications, open simultaneously. Even though a user may be logged into a site, and the system is tracking them as logged in, the end user may have multiple screens open and the information currently collected is highly inaccurate. Additionally, none of the current systems allow for return on investment (ROI) calculations, nor do they identify and alert to declines in individual usage activity.

As can be seen, there is a need for a method for tracking and reporting usage activity on computing devices coupled to a computing environment for determining overall efficiency and efficacy. The present invention differs from the prior art in that it measures active time, when the user is actually looking at the content, allowing administrators to track and categorize any web site or application, not merely a list of pre-populated ones. The present invention is also adapted to run ROI reports, to analyze the actual usage versus the recommended usage. Lastly, the present invention alerts device users whose usage activity, as measured by the time usage on categorized sites and applications as compared to recommended usage, is indicative of becoming less focused on their task.

### SUMMARY OF THE INVENTION

In one aspect of the present invention, user-activity tracking system for collecting and analyzing the time usage of a plurality of content on a computer having a user interface and at least one input device includes a tracking software installed on the computer for tracking active usage of the plurality of content thereon; the tracking software configured to time all of the plurality of content represented on the user interface; the tracking software configured to detect activity input of the at least one input device when it operative engages any of the plurality of content; and the tracking software configured to define a status for each of the plurality of content as active usage.

In another aspect of the present invention, the user-activity tracking system for collecting and analyzing the time usage of a plurality of content on a computer having a user interface and at least one input device includes activity input as mouse device input, keyboard input, or audio input operatively associated with any content of the plurality of content; a tracking software installed on the computer for tracking active usage of the plurality of content thereon; the tracking software configured to time all of the plurality of content represented on the user interface; the tracking software configured to time the active usage of each of the plurality of content; the tracking software configured to detect activity input of the at least one input device when it operative engages any of the plurality of content; and the tracking software configured to define a status for each of the plurality of content as active usage, wherein inactive usage comprises the status not being defined as active usage, and wherein active usage status comprises a respective content of the plurality of content front facing on the user interface, after launch thereof and prior to any activity input operatively associated with another content of the plurality of content, or after activity input operatively associated therewith and prior to any activity input operatively associated with another content of the plurality of content.

In yet another aspect of the present invention, a method of determining efficacy of each content of the plurality of content provided by the system of claim 8, includes the steps of receiving a recommended usage time for a third party for each content of the plurality of content for a certain predetermined task; establishing a benchmark for an efficacy ratio of the recommended usage time to the time of active usage for a respective content of the plurality of content during performance of the certain predetermined task; and determining if said efficacy ratio meets the benchmark.

And in yet another aspect of the present invention, a method of improving time-on-task behavior for a user of the computer performing the certain predetermined task of claim 9, comprising the step of sending a notification to the user via the computer if said efficacy ration does not meet the benchmark for the certain predetermined task.

These and other features, aspects and advantages of the present invention will become better understood with reference to the following drawings, description and claims.

### BRIEF DESCRIPTION OF THE DRAWINGS

The FIGURE is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for tracking and reporting usage activity on computing devices that embodies a method determining overall efficiency and efficacy by measuring active usage time when the user is actually engaging or looking at the content. The method enables administrators to track and categorize any web site or application and run resulting ROI reports comparing quantified actual usage versus the recommended usage. Thereby the present invention may alert device users whose usage activity, as measured by the time usage on categorized sites and applications, deviates from recommended usage or predetermined thresholds.

Referring to the Figure, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a usage activity system 100 for tracking and reporting usage activity on computing devices that embodies a method determining overall efficiency and efficacy by measuring active time when the user is actually engaging or looking at categorized content.

The embodied method includes installing client tracking software on each computing device connected to a computing environment. The data tracking software is operable across multiple operating systems and adapted to manage a cloud-based dashboard for collecting, analyzing and reporting the data. The computing environment may include a cloud dashboard 20 adapted to map each computing device to specific users, thereby enabling the software to track by organization as well as by the individual user. The client tracking software measures active usage time of categorized content, but only when such content is actively visible on a user interface, thereby giving a more accurate report of time used. Categorized content may include websites, programs, application or the like that is preapproved by an authorized administrator 30 (e.g., an institution, organization, entity, individual, or the like). The tracking system 100 is enabled so that authorized administrators 30 may categorize content by level of effectiveness.

The dashboard 20 compiles usage data on unlimited categorized content, enabling the authorized administrators 30 to track and identify gaps in “time-on-task behavior” for individual users, as an early warning detection of those dis-engaging from their work. Furthermore, the present invention may compile non-personally identifying usage data across many institutions in states and/or countries, affording an opportunity to provide industry-wide and vertical-wide audience data for specific categorized content.

The dashboard 20 may be coupled to a ROI calculator adapted to determine the return on investment, by comparing actual active usage versus vendor-recommended usage and amount paid for the service plus the number of licenses purchased. The ROI calculator may be adapted to recommend next steps to the authorized administrators 30, whether they should keep the categorized content at its current price, cancel it, renegotiate the price based upon actual usage data, or identify the need for additional training and support to improve usage results.

The usage activity system 100 includes a plurality of user computing devices coupled in a computing environment, wherein a portion of the plurality of user computing devices may be associated with one or more authorized administrator 30, wherein there may be a plurality of such portions, and wherein the tracking software disclosed above may be installed on each computing devices. Also coupled to the computing environment may be a master hosted database, a cloud analytics engine, at least one third part dashboards 40, and a cloud dashboard for each authorized administrator 30.

Through this usage activity system 100 the software tracks actual active usage data for each coupled computing device. The software may be adapted to recognize the difference between websites, programs, software, applications and other digital content that is running but minimized outside of view (“inactive usage”) and those same sources of content in actual user view (“active usage”). The status of active usage may be deemed for a particular content if it is front facing on the user interface, immediately after launch prior to any activity input associated with another content, or immediately after activity input associated with said particular content but prior to any activity input associated with another content. Because users often run multiple software programs and open many web pages simultaneously, the data tracking software (1) will need to determine what screens are in active use for accurately (cumulative) timing active and inactive usage. Activity input may include mouse device or keyboard input, digital pen, stylus, haptic, audio and/or input/output elements operatively associated with said particular content. Video input may include a user on Skype™ or Facetime™ using video as their primary input. By “screen” or “user screen,” the instant disclosure includes web page or application running on the end user device/user interface. If a user screen of a respective categorized content is minimized on a respective computing device, the software changes the status from active to inactive usage, halting time counting the usage as active usage until said user screen is visible again on the computing device. In certain embodiments, in order to be deemed inactive usage, the user screen must be opened on the device, but not actively displayed as not front facing, another content has experience the last activity input, or a predetermined amount of time has lapsed. For example, if there was no further activity input for x-amount of time, the status would be deemed inactive usage after that x-amount of time. Also, if a child opened Microsoft Excel and minimized it for 3 hours, that would be 3 hours of inactive use.

Each type of usage may be quantified as time-based usage data. Such time-based usage data may be exported regularly or in real time to the cloud dashboard 20, where the authorized administrator 30 can view actual usage data by the overall organization, sub-group or individual user.

The time-based usage data may also be compared to time-based recommended usage on a program-for-program basis, wherein the recommended usage is provided from a third party, such as a vendor; possibly through one of the plurality of third party databases 40. From a comparison between the active usage and the recommended usage ROI reporting may be determined, helping the authorized administrator 30 understand whether or not users are seeing a direct benefit from the hardware, software, websites and digital content being provided by the third parties, as well as the efficacy of a change management associated with a predetermined digital initiative.

For ROI report, if cumulative usage percentage (for example, the ratio of active usage to the sum total of active and inactive usage) for a particular categorized content falls below a benchmark established by the authorized administrator 30, then the tracking system 100 may recommend cancelling or re-negotiating the subscription.

The time-based usage data also enables the ability to track and identify gaps in “time-on-task behavior” on individual users, as an early warning detection for those users dis-engaging from their efforts. For further detailed analysis against other criteria not tracked in this system, authorized administrators can export the data to third party analytic tools. In the context of “time-on-task behavior”, if an individual user's personal “time on task” falls below an established benchmark set by the authorized administrator 30 (fixed time or percentage thereof), then the system may be adapted to send an alert to the authorized administrator 30 and or individual user.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A user-activity tracking system for collecting and analyzing the time usage of a plurality of content on a computer having a user interface and at least one input device, comprising:
a tracking software installed on the computer for tracking active usage of the plurality of content thereon;
the tracking software configured to time each content of the plurality of content represented on the user interface as a user screen;
the tracking software configured to detect activity input of the at least one input device when it operative engages any of the plurality of content; and
the tracking software configured to define a status for each of the plurality of content as active usage.

2. The system of claim 1, wherein inactive usage comprises the status not being defined as active usage for each content providing a respective user screen.

3. The system of claim 1, wherein active usage status comprises a respective content of the plurality of content front facing on the user interface.

4. The system of claim 3, wherein active usage status comprises a respective content of the plurality of content after launch thereof and prior to any activity input operatively associated with another content of the plurality of content.

5. The system of claim 3, wherein active usage status comprises a respective content of the plurality of content after activity input operatively associated therewith and prior to any activity input operatively associated with another content of the plurality of content.

6. The system of claim 1, wherein activity input includes input from a mouse device, a keyboard, a digital pen or stylus, haptic, audio or video input devices operatively associated with any content of the plurality of content.

7. The system of claim 1, further comprising the tracking software configured to time the active usage of each of the plurality of content.

8. A user-activity tracking system for collecting and analyzing the time usage of a plurality of content on a computer having a user interface and at least one input device, comprising:
activity input includes input from a mouse device, a keyboard, a digital pen or stylus, haptic, audio or video input devices operatively associated with any content of the plurality of content;
a tracking software installed on the computer for tracking active usage of the plurality of content thereon;
the tracking software configured to time all of the plurality of content represented on the user interface;
the tracking software configured to time the active usage of each of the plurality of content;
the tracking software configured to detect activity input of the at least one input device when it operative engages any of the plurality of content; and
the tracking software configured to define a status for each of the plurality of content as active usage, wherein inactive usage comprises the status not being defined as active usage, and
wherein active usage status comprises a respective content of the plurality of content front facing on the user interface, after launch thereof and prior to any activity input operatively associated with another content of the plurality of content, or after activity input operatively associated therewith and prior to any activity input operatively associated with another content of the plurality of content.

9. A method of determining efficacy of each content of the plurality of content provided by the system of claim 8, comprising the steps of:
receiving a recommended usage time for a third party for each content of the plurality of content for a certain predetermined task;
establishing a benchmark for an efficacy ratio of the recommended usage time to the time of active usage for a respective content of the plurality of content during performance of the certain predetermined task; and
determining if said efficacy ratio meets the benchmark.

10. The method of improving time-on-task behavior for a user of the computer performing the certain predetermined task of claim 9, comprising the step of:
sending a notification to the user via the computer if said efficacy ratio does not meet the benchmark for the certain predetermined task.
